(19) United States
(12) Patent Application Publication
(10) Pub. No.: US 2017/0058238 A1
(43) Pub. Date: Mar. 2, 2017

(54) Composition for Waste Drain Maintenance and Method of Use

(71) Applicant: Anthony R. Budroe, Macedonia, OH (US)

(72) Inventor: Anthony R. Budroe, Macedonia, OH (US)

(21) Appl. No.: 14/837,232

(22) Filed: Aug. 27, 2015

(51) Int. Cl. C11D 3/386; C11D 3/10; C11D 3/382; C11D 3/20

(52) U.S. Cl. CPC C11D 3/386; C11D 3/2079; C11D 3/2086; C11D 3/10; C11D 3/382

(57) ABSTRACT

A composition for waste drain maintenance and the method of use thereof is presented. A composition of dry ingredients, including worm grind, vinegar, citrus rind, citric acid, brown sugar, baking soda, and fruit extract is provided. When placed in a drain and activated by water, enzymatic action occurs that breaks down and dissolves many of the greases, fats, and particulate matter that tends to adhere to the inner surface of drain pipes, slowing discharge and eventually leading to clogs. Placement of a couple of tablespoons of the composition into a drain, followed by about a quart of water, and leaving the same to stand for a period of time, such as overnight, allows for the decomposition of the offensive material on the drain walls. The dissolved, decomposed material can then be flushed away as an effluent by the addition of an adequate quantity, such as a gallon, of fresh water.

### TECHNICAL FIELD

The invention herein resides in the art of waste drain maintenance and, more particularly, to a dry composition of material particularly adapted for periodic use in household drains and the like. More particularly, the invention relates to a composition of reactive, enzymatic, and solvent-type materials that serve to break down, dissolve, and decompose materials that tend to clog drain pipes. The invention also relates to the use of such a composition on a periodic basis to maintain the drain pipes free of buildup along the inner walls that would otherwise tend to reduce the flow of liquids therethrough and ultimately lead to clogging.

### BACKGROUND OF THE INVENTION

Today most buildings and facilities have one or more drains for removing waste water or the like from the building to a sewage system. In residential homes, kitchen and bathroom sinks, toilets, showers, floor drains and the like all serve this purpose. However, it is not simply clear water that is passed into the drains, but rather water that is oftentimes laden with materials having a tendency to cling to the drain walls and begin a buildup of materials that ultimately leads to a clog. Body lotions and conditioners, as well as cooking oils, fats and grease are common constituents of the effluent that passes into household drains, ultimately leading to significant or total clogging of the drain system. As a result, drain cleaners or professional plumbers are often required to open the drain, but typically that only provides temporary relief while the cycle of buildup begins anew and continues. If the drains were kept clean by periodic treatment, clogs could be prevented altogether.

There is a need in the art for a composition for waste drain maintenance and a method of use thereof that can serve to ensure that household drains remain open without the threat of waste buildup and eventual clogging.

### DISCLOSURE OF INVENTION

In light of the foregoing, it is a first aspect of the invention to provide a composition for waste drain maintenance that includes enzymes that can adhere to the inner surfaces of drain pipes and serve to breakdown fats, grease and the like.

It is another aspect of the invention to provide a composition for waste drain maintenance that includes a solvent-type ingredient that can decompose eggshells, bones, and the like that may find their way into the drain.

It is a further aspect of the invention to provide a composition for waste drain maintenance that is a dry mixture having an extended shelf life.

Still a further aspect of the invention is the provision of a composition for waste drain maintenance that consists of environmentally friendly natural ingredients that do not pose a threat to humans or their pets.

Yet a further aspect of the invention is the provision of a method of use of a composition for waste drain maintenance having the above features and in which the use of the composition is simple, yet effective.

An additional aspect of the invention is the provision of a method of use of the composition for waste drain maintenance presented above in which the composition is easy to manufacture from readily available materials and the method of use is conducive to implementation by homeowners.

The foregoing and other aspects of the invention that will become apparent as the detailed description proceeds are achieved by a composition for waste drain maintenance comprising worm grind, vinegar, citric acid, and baking soda, all comprising dry ingredients.

Still further aspects of the invention are achieved by a method for maintaining water drains comprising: introducing 2-4 tablespoons of an enzymatic composition into a drain; adding 15-50 ounces of water into the drain to react with the composition and provide an effluent of water and composition within the drain; allowing said effluent to dwell within the drain for 6-10 hours; flushing said effluent from said drain with water; and wherein said enzymatic composition comprises worm grind, dry vinegar, granule citric acid, and baking soda.

### DETAILED DESCRIPTION OF PREFERRED EMBODIMENT

The present invention contemplates a composition of ingredients that can be periodically introduced into a drain system to break down, dissolve, and remove the aggregation of materials that tend to build up on the interior surfaces of drain pipes. While the composition is seen as most beneficial for households, it can be equally effective for use in commercial establishments, such as restaurants and the like, with increased frequency of application. A preferred embodiment of that composition is presented below with the various ingredients identified as to their volumetric contribution to the composition as a whole.

A first ingredient to the composition is granule worm grind, contributing 0.01-0.05% of the composition by volume. The worm grind is an enzyme that adheres to the inner surface of the drain pipe and serves to break down fats, grease, body lotions and the like that tend to adhere to the inner surface of the drain pipes. In a most preferred embodiment of the invention, the worm grind constitutes 0.03% of the composition as a whole.

A next ingredient for the composition is dry vinegar, which serves as a solvent that acts to decompose eggshells, bone and the like, which may otherwise be found in the drain, often entrapped by the fats and grease adhering to the walls of the pipe. In a preferred embodiment of the invention dry vinegar provides 25-35% by volume of the final composition. In a most preferred embodiment, the dry vinegar comprises 30% by volume.

Granule dry citrus rind is also provided as a portion of the composition of interest. The citrus rind serves as an enzyme that contributes to and accelerates the decomposition of materials within the drain. Preferably, the granule dry citrus rind constitutes 0.02-0.05% of the final composition by volume, and most preferably 0.03%.

Granule citric acid is also included in the composition, again serving as an enzyme to assist in decomposition as the dry citrus rind. Its presence in the composition is on the order of 8-10%, most preferably 9% by volume.

Granule brown sugar is also an enzyme included in the composition and serves to attach to grease and fats and assists in breaking them down. The brown sugar is present in the composition in the range of 0.05-0.07% by volume, and most preferably on the order of 0.06%.

Baking soda is provided as a significant volumetric ingredient of the composition. The baking soda not only reacts with the dry vinegar to foam when water is added (discussed below), but also serves to absorb odor that may result during the various enzymatic activities. Baking soda is presented in the volumetric range of 25-30%, and most preferably on the order of 28%. The foaming activity assists in attaching to particulate matter being dissolved by the enzymatic actions discussed above, and carrying the same away when flushed, as discussed below.

As a further ingredient to the composition, a fruit extract, such as that of apple or peach, may be provided to the composition to mask odors not otherwise absorbed by the baking soda. At the very least, the fruit extract serves to mask or obscure what might otherwise be deemed an offensive odor from the drain. The fruit extract, if desired, may be placed in the composition volumetrically at 10-15%, and most preferably on the order of 13%.

It should be apparent from the foregoing that the composition of the invention is that of a plurality of safe ingredients, none being harmful to humans, pets, or the environment. The composition has been found to have a shelf life of a year or more, particularly when stored outside of direct sunlight and in temperatures between 40°-100° F.

In use, household drains are preferably treated on a 3-month cycle. The treatment includes placement of 2-3 tablespoons of the composition into a drain. The dry composition, once placed in the drain is activated with water, typically on the order of a quart of water, being sufficient not only to activate, but also to transport the composition into and through any associated trap and the early stages of a drain pipe connected thereto. The drain is then inactivated for a period of 6-10 hours, and preferably overnight, and then flushed with clean running water in the amount of approximately one gallon.

It has been found that the composition presented above, when used in the manner just described, will keep household drains clean, removing any buildup on the drain pipe walls, and significantly reducing the risk of any buildup of such a nature as to restrict drainage flow or actually result in a clog. Such not only contributes to peace of mind of the homeowner, but also eliminates the need for the self-help application of caustic drain cleaners and/or the hiring of a professional plumber to remove clogs that could otherwise have been avoided.

Thus, it can be seen that the various aspects of the invention have been achieved by the structure presented and described above. While in accordance with the patent statutes, only the best known and preferred embodiment of the invention has been presented and described in detail, the invention is not limited thereto or thereby. Accordingly, for an appreciation of the true scope and breadth of the invention, reference should be made to the following claims.

What is claimed is:

1. A composition for waste drain maintenance, comprising worm grind, vinegar, citric acid, and baking soda.

2. The composition for waste drain maintenance according to claim 1, further comprising an aromatic ingredient.

3. The composition for waste drain maintenance according to claim 2, further comprising dry citrus rind and granule brown sugar.

4. The composition for waste drain maintenance according to claim 1, wherein said vinegar is dry and said worm grind is granule, said worm grind comprising 0.01-0.05% of said composition by volume.

5. The composition for waste drain maintenance according to claim 4, wherein said citric acid is granule.

6. The composition for waste drain maintenance according to claim 5, wherein said baking soda comprises 25-30% of the composition by volume.

7. The composition for waste drain maintenance according to claim 6, wherein said dry vinegar comprises 25-35% of the composition by volume.

8. The composition for waste drain maintenance according to claim 7, wherein said citric acid comprises 8-10% of the composition by volume.

9. The composition for waste drain maintenance according to claim 8, wherein said granule dry citrus rind comprises 0.02-0.05% of the composition by volume.

10. The composition for waste drain maintenance according to claim 9, further comprising 0.02-0.05% granular dry citrus rind by volume.

11. The composition for waste drain maintenance according to claim 10, further comprising 0.05-0.07% granule brown sugar by volume.

12. The composition for waste drain maintenance according to claim 11, further comprising 10-15% fruit extract by volume.

13. The composition for waste drain maintenance according to claim 12, wherein said fruit extract is selected from the group of apple and peach.

14. A method for maintaining water drains, comprising:
introducing 2-4 tablespoons of an enzymatic composition into a drain;
adding 15-50 ounces of water into the drain to react with the composition and provide an effluent of water and composition within the drain;
allowing said effluent to dwell within the drain for 6-10 hours;
flushing said effluent from said drain with water; and
wherein said enzymatic composition comprises worm grind, dry vinegar, granule citric acid, and baking soda.

15. The method for maintaining water drains according to claim 14, wherein said composition comprises 0.01-0.05% worm grind, 25-35% vinegar, 8-10% citric acid, and 25-35% baking soda.

16. The method for maintaining water drains according to claim 15, wherein said worm grind is granule, said vinegar is dry, and said citric acid is granule.
